(19) United States
(12) Patent Application Publication
(10) Pub. No.: US 2025/0156401 A1
(43) Pub. Date: May 15, 2025

(54) Auto Computation of Counters and Last-N features across High Cardinality Dimensions in Distributed Systems

(71) Applicant: Elasticflash, Inc., Palo Alto, CA (US)

(72) Inventors: Darshan Bharatkumar Rawal, Fremont, CA (US); Naoki Iwakami, Redwood City, CA (US); Pradeep Jnana Madhavarapu, Cupertino, CA (US)

(73) Assignee: Elasticflash, Inc., Palo Alto, CA (US)

(21) Appl. No.: 18/945,371

(22) Filed: Nov. 12, 2024

Related U.S. Application Data
(60) Provisional application No. 63/597,425, filed on Nov. 9, 2023.

(51) Int. Cl. G06F 16/23; G06F 16/22

(52) U.S. Cl. CPC G06F 16/2379; G06F 16/2264

(57) ABSTRACT

Systems and methods for computing counters in a distributed system are described. One embodiment includes receiving a counter update request, that includes at least one counter entry each including a timestamp, an operation value, a first set of dimension values, and at least one counter value, writing to a counter ledger, where the counter ledger comprises an immutable table where each entry has a first timestamp, an operation, a first set of dimensions, and a first at least one counter state, each counter state restricted to numeric values, reading a latest counter snapshot from an immutable snapshot ledger, generating a new counter snapshot from the latest counter snapshot and selected counter entries in the counter ledger, where the new counter snapshot includes the second set of dimension values, a second timestamp, at least one snapshot counter value, writing the new counter snapshot to the snapshot ledger.

### CROSS-REFERENCE TO RELATED APPLICATIONS

The current application claims priority under 35 U.S.C. 119(e) to U.S. Provisional Patent Application Ser. No. 63/597,425, entitled “Distributed Counter State Management Across Hierarchical Dimensions”, filed Nov. 9, 2023. The disclosure of U.S. Provisional Patent Application No. 63/597,425 is hereby incorporated by reference in its entirety.

### BACKGROUND

Most Big Data processing requires the ability to onboard, process, and operate data. This enables application builders to build data and artificial intelligence (AI) use cases.

Typically, these systems include high-perform write-optimized storage (e.g., AWS S3/Object stores), queuing/streaming systems (e.g., Apache Kafka/Flink), ETL pipelines to process/transform data based upon map-reduce frameworks (e.g., Apache Spark) and read-optimized databases (e.g., Redis/HBase) to store features that applications can consume. These sub-components offer different freshness, performance, and accuracy trade-offs while embodying a significant tax on the operational aspects to achieve these use cases.

Counters and Last-N are two of the most critical features that application builders require to deliver Data and AI use cases.

Counters and Last-N features are difficult and expensive to implement in distributed systems, especially when fault tolerance is considered. Further, many use cases for distributed counters require a state machine. For example, when an order is placed in a stock exchange (or any other environment where orders for items can be placed), the counter of available items must be reduced by the order size, and the processing counter needs to be incremented by the order size. Further, these state changes have to fulfill several requirements:

The state changes need to be atomic, such that changes are all or nothing within the distributed system.

The state changes need to be durable such that updates/writes are fault-tolerant across multiple copies of data in various data centers of the distributed system.

The state changes need to be consistent such that when an application performs a read on the counter right after an update, the results are always accurate.

Current solutions require trading off performance (low latency), scalability (throughout), reliability (accuracy of the counter), and complexity (e.g., total cost of ownership of the solution).

### SUMMARY OF THE INVENTION

Systems and methods for computing counters in a distributed system are described. One embodiment includes receiving a counter update request, that includes at least one counter entry each including a timestamp, an operation value, a first set of dimension values, and at least one counter value, writing to a counter ledger, where the counter ledger comprises an immutable table where each entry has a first timestamp, an operation, a first set of dimensions, and a first at least one counter state, each counter state restricted to numeric values, reading a latest counter snapshot from an immutable snapshot ledger, generating a new counter snapshot from the latest counter snapshot and selected counter entries in the counter ledger, where the new counter snapshot includes the second set of dimension values, a second timestamp, at least one snapshot counter value, writing the new counter snapshot to the snapshot ledger.

### BRIEF DESCRIPTION OF THE DRAWINGS

FIG. 1 is a block diagram of an example network environment in accordance with several embodiments of the invention.

FIG. 2A illustrates an example log and snapshot, and compactor operation, in accordance with an embodiment of the invention.

FIGS. 2B-2E illustrate indexing of a counter ledger and counter snapshots in accordance with an embodiment of the invention.

FIG. 3 is a block diagram of an example computing device in accordance with several embodiments of the invention.

FIG. 4 illustrates a process for updating a counter ledger and generating snapshots in accordance with embodiments of the invention.

FIG. 5 illustrates a process for requesting counter snapshots in accordance with embodiments of the invention.

### DETAILED DESCRIPTION

Systems and methods for counter-state management in accordance with embodiments of the invention can onboard, process, and prepare insights from structured, semi-structured, and unstructured data so that applications can consume it. Data may be onboarded using database syntax, i.e., insert commands. Data may be entered into a counter ledger and ordered within the counter ledger by timestamps generated by a data source client based upon time-based Universally Unique Identifier (e.g., UUID v3).

A counter ledger server can “bucket” data records into a higher granularity (e.g., by a time index). The data records can be schema-validated and stored within the database with three copies of data across 3 data centers with QUOROM consistency. Pre-storage, some minor “joins” can be performed.

Using a declarative configuration, data can be auto-processed. Processing may involve indexing across hierarchical dimensions.

A first example of data processing in accordance with embodiments of the invention is determining the LAST-N values of a column or a set of columns indexed by a variety of dimensions (e.g., find the last 10 products that this anonymized session clicked on). A second example is determining the count of a numerical column or a set of columns such that it can process “DELTA” values or “SNAPSHOT” Values. (e.g., retail inventory, stock trading, etc.).

Such processing to create snapshots can be done periodically at a user-defined frequency (e.g., a few milliseconds to minutes).

### Computing Environment

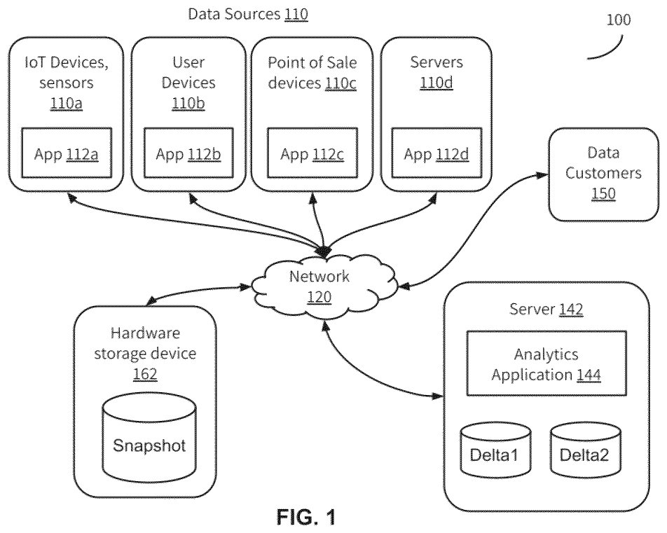

FIG. 1 illustrates a block diagram of an example network environment 100, which may be used in some implementations described herein. Environment 100 includes data sources 110, server 142, data customers 150, and hardware storage device 162, all coupled via network 120.

Environment 100 may include one or more devices that act as sources of data. Data sources 110 may include, for example, devices or sensors 110a, user devices 110b (e.g., mobile phones, tablets, laptops, wearable devices, personal health devices, fitness trackers, etc.), point of sale devices 110c (e.g., in-store point of sale terminals), servers 110d (e.g., web servers that provide data such as clicks on particular web pages, e-commerce servers that provide transactional data, financial servers that provide banking, stock market and other financial data, other database servers,), microservices, apps (e.g., smartphone apps, apps for wearable devices, etc.), file servers, e.g., that provide comma-separated value (CSV) files, eXtensible Markup Language (XML) files, log structured files, etc. Devices 110a-110d are collectively referred to as data sources 110 henceforth.

Each of data sources 110 may be configured with a corresponding application 112 (or app). For example, IoT devices/sensors 110a may include app 112a, User devices 110b may include app 112b, PoS devices 110c may include app 112c, and servers 110d may include app 112d. Applications 112 may provide functionality for data generated by a data source 110 to be sent to a distributed database for storage. Applications 112 may also provide other functionality. In some implementations, an application 112 may include an application component, e.g., a library, provided by a third-party other than a developer of application 112. For example, the application component may be provided by a cloud computing vendor that provides data storage and/or analytics services. For example, the application component may be part of a software development kit (SDK) provided by the cloud computing vendor. Data sources 110 may be coupled to network 120.

In some implementations, data sources 110 may be configured to send data via network 120. For example, such data may include sensor readings from sensor 110a, data obtained by user device 110b such as location information, user activity information (e.g., heart rate, websites visited, etc.), sales data from PoS device 110c (e.g., transaction records, payment method used for a transaction, SKUs of items purchased, etc.), or data from servers 110d (e.g., click data from a web server, logs from a firewall, purchase data from an e-commerce server, data from cameras or image sensors including image metadata such as timestamps, location, etc., radar/LIDAR data, etc.). Data sources 110 can utilize an application 112 to send data to server 142 via network 130. Data sources 110 may send data over network 120, e.g., as a data stream.

A data stream may include one or more data records. Each data record may have one or more data fields. For example, a data source 110 may generate data records from transactional activity, e.g., a periodic temperature reading obtained by a sensor, an order being recorded by a PoS device or e-commerce server, a user logging in or out of an online service, etc. The records may include timestamps and may be provided as a data stream that is updated whenever a transaction event occurs, when a certain number (e.g., 10) of transaction events occur, periodically (e.g., once a minute), or a combination of any of these. Thus, a data stream, as recited herein, may be a flow of data from data sources 110.

Environment 100 may further include data customers 150. For example, data customer 150 may include computing devices, e.g., reporting and analytics servers, that analyze data stored on hardware storage device 162. Reporting and analytics servers may execute software that analyzes data, including machine-learning algorithms, applications that include business logic to perform one or more actions based on the data, software utilized by data scientists to perform ad-hoc data analyses, etc. In some implementations, data customers 150 may generate requests, e.g., requests for top-N identifiers in a particular time period. In some implementations, responses to the requests may be utilized to perform actions in a transactional application, to provide a user interface such as interactive reports, or dashboards, etc. based on responses received from server 142.

Environment 100 may further include a server 142 that includes a counter analytics application 144. Counter analytics application 144 may perform all or part of processes discussed further below, to compute a snapshot, to obtain counter update requests, and to respond to snapshot requests, e.g., from data customer 150. For example, server 142 may write or update a counter ledger and snapshot ledger as discussed further below. Server 142 may be configured in communication with hardware storage device 162 and may write data (e.g., counter ledger and/or snapshot ledger) to hardware storage device 162. Hardware storage device 162 may be on server 142 or may be separate from server 142. While a single server is shown in FIG. 1, different implementations may include a plurality of servers, e.g., arranged in a cluster or a distributed system, that together provide functionality of server 142.

In different embodiments of the invention, any number of hardware storage devices may be provided. Hardware storage device 162 may be a distributed storage system that includes replicated copies of the same data across multiple storage devices. Hardware storage device 162 may include other types of storage hardware, e.g., dynamic random-access memory (DRAM), 3DXpoint memory, solid-stage storage (e.g., flash), hard disk drives, etc. Distributed data storage may provide data resiliency.

In some embodiments of the invention, one or more elements of environment 100 may be part of a data center (e.g., of a cloud computing provider), and other elements may be outside the data center. For example, as illustrated in FIG. 1, data sources 110 may be outside the data center, e.g., situated at geographic locations distinct from that of the data center. Such elements may be referred to as being outside the perimeter of the data center.

In some embodiments of the invention, one or more elements may be within a single data center, or multiple data centers, e.g., managed by a cloud computing provider. A trusted perimeter may be defined within the data center or multiple data centers which houses elements that are relatively secure and protected from external threats. The security of such elements may arise from their physical location (e.g. low risk of access from hackers, intruders, etc.), the configuration of such elements, or combinations thereof. Such elements may be referred to as being within the trusted perimeter of the data center. The cloud computing provider may control the elements within the trusted perimeter of the datacenter, e.g., start/stop, reboot, disconnect from network, etc. while the cloud computing provider does not control elements outside the trusted perimeter.

The environment may also include various elements that lie outside the trusted perimeter. These may include third party devices (e.g. sensors, computers, etc.) and systems that communicate with elements within the trusted perimeter of the data center, and which may pose a higher security risk within the environment (e.g. sensors that may be stolen and/or reconfigured, third party hardware and software elements that may be hacked, etc.).

While a specific system is described above with respect to FIG. 1, one skilled in the art will recognize that any of a variety of system configurations may be utilized in accordance with embodiments of the invention.

### Counters, Counter Ledger, and Snapshot Ledger

Techniques are described herein for utilizing a counter ledger and one or more snapshot ledgers to provide timely and current counts of data items that were provided from data sources to a server with minimal additional processing (e.g., ETL extract, transform, load).

Many embodiments of the invention implement a counter as a numerical value that represent an accumulated count of occurrences of some combination of field values as dimensions that characterize an occurrence. Counters are useful in data processing as applied to many different areas. The techniques described can be used in any distributed system where counters are utilized. For example, the techniques can be used for inventory management (e.g., where a counter refers to the inventory for an individual item), stock trading (e.g., where the counter refers to quantities of stock), score counting, Internet-of-Things (IoT) sensor data, travel reservations, etc.

In an e-commerce scenario the occurrence to count may be unique visitors to a website. The dimensions for the count may include the browser used, IP address, service provider, etc. for each unique visit session. A counter state can represent the number of times a user visits the website. The combination of values for these dimensions may attempt to encapsulate a single user. To count products that a user is interested in, additional dimensions can include a product listing page, product identifier, product category, etc. These dimensions may be taken from product listing pages within the website that the user has clicked on.

In another example for inventory management, the dimensions for a count can include an identifier for a fulfillment center (warehouse holding items), city, state, and zip code where the fulfillment center is located. The counter states can each represent the number of a particular item that is present and in stock at that fulfillment center. When the stock is updated, a counter can be incremented or decremented according to the change in the inventory number.

Embodiments of the invention can generate up-to-date absolute counter values at periodic intervals, e.g., at a user-defined frequency, by consolidating counter entries placed in counter ledger to generate snapshots. Snapshots may be stored in a snapshot ledger. For example, the counter analytics application can set the frequency of snapshots. The process of generating snapshots from counter entries in a counter ledger can referred to as counter compaction.

In some embodiments of the invention, counters can store other data types beyond numerical values. For example, a counter can store a string. This can support another type of count called Last-N. When a counter state stores a string, a query or snapshot can return the most recent N counter entries that match the criteria of the Last-N request.

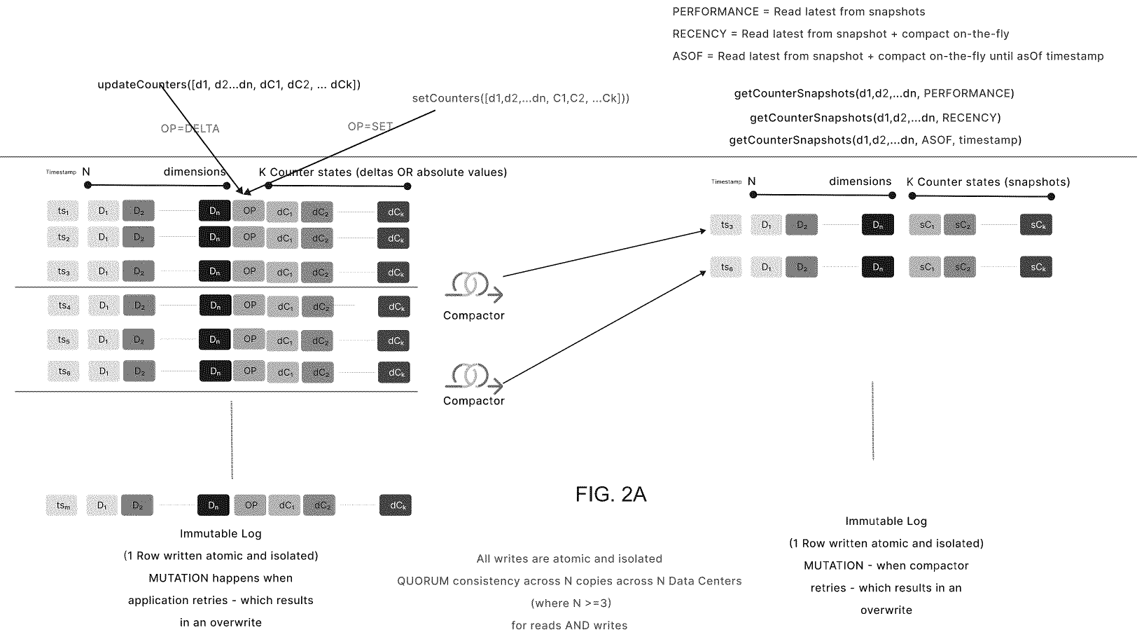

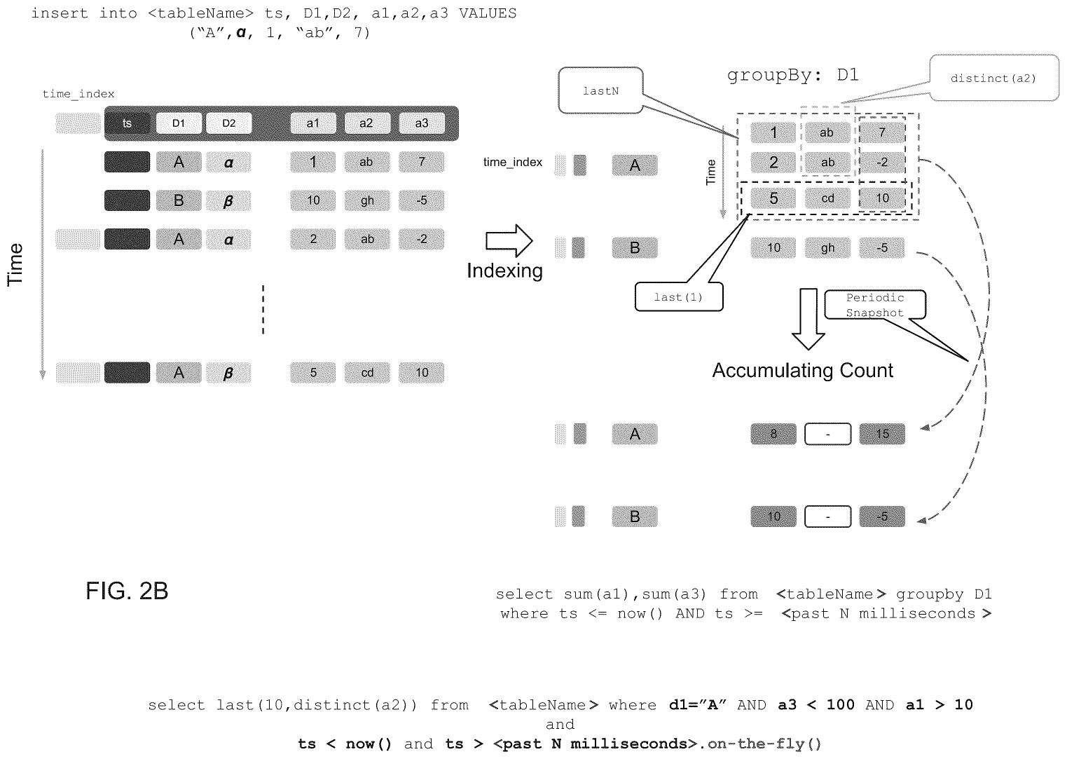

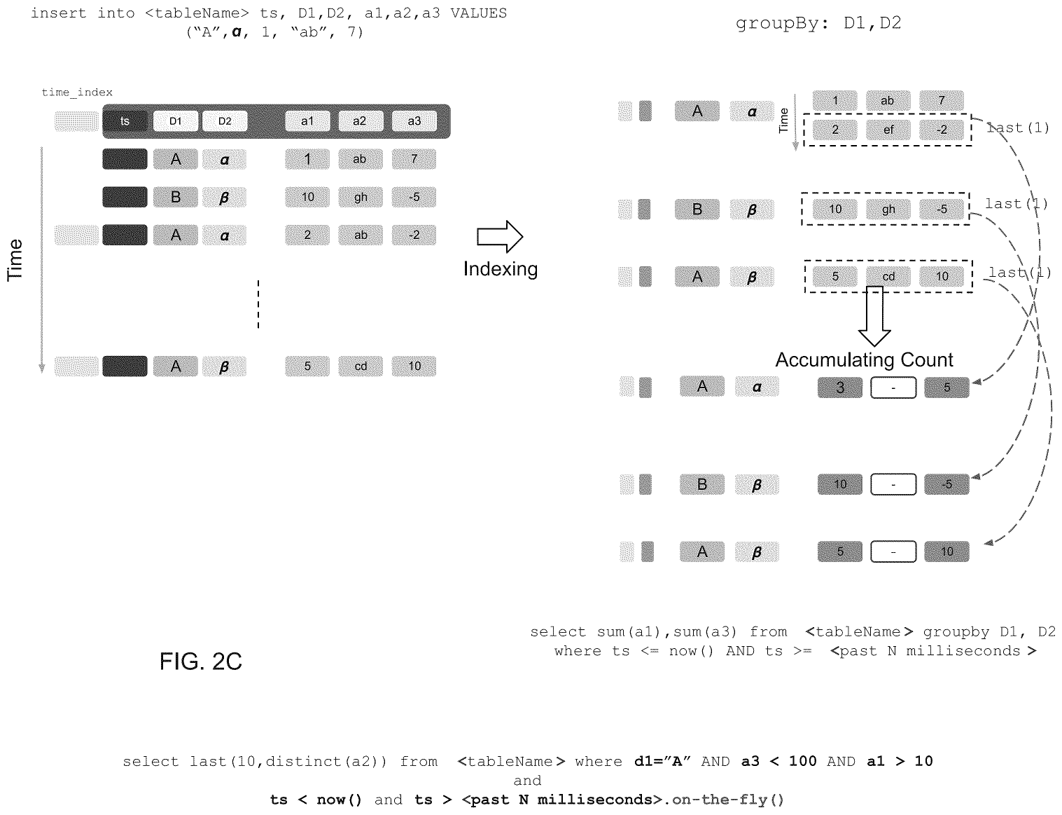

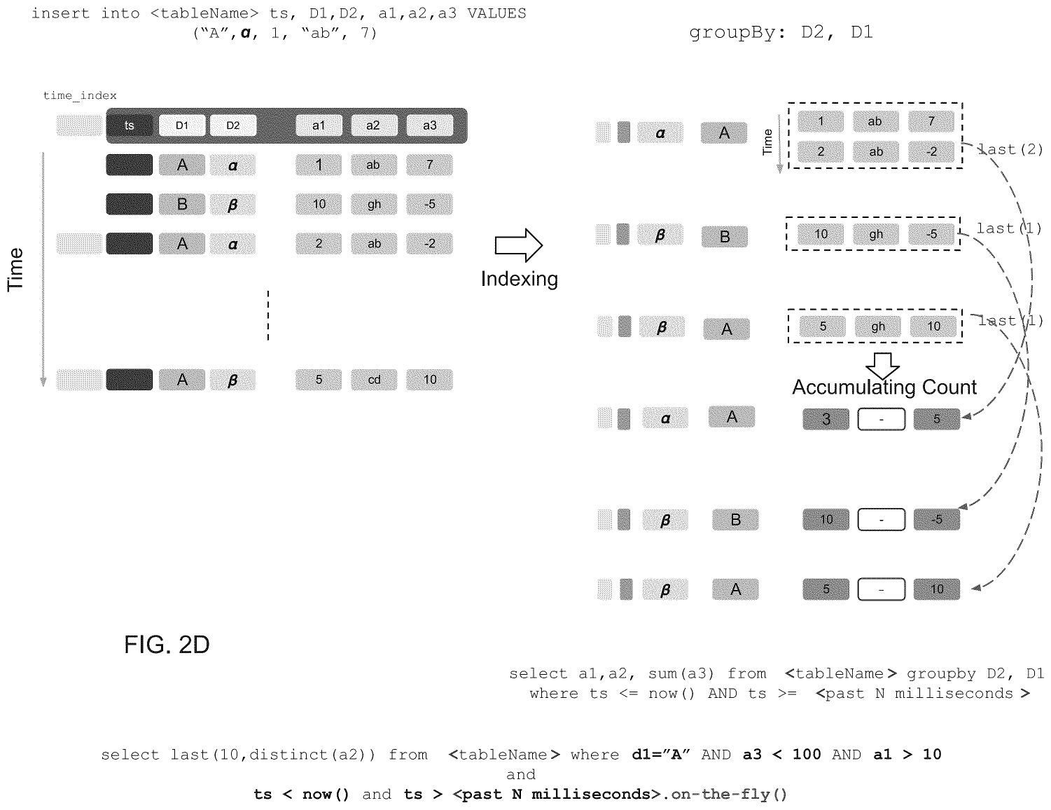

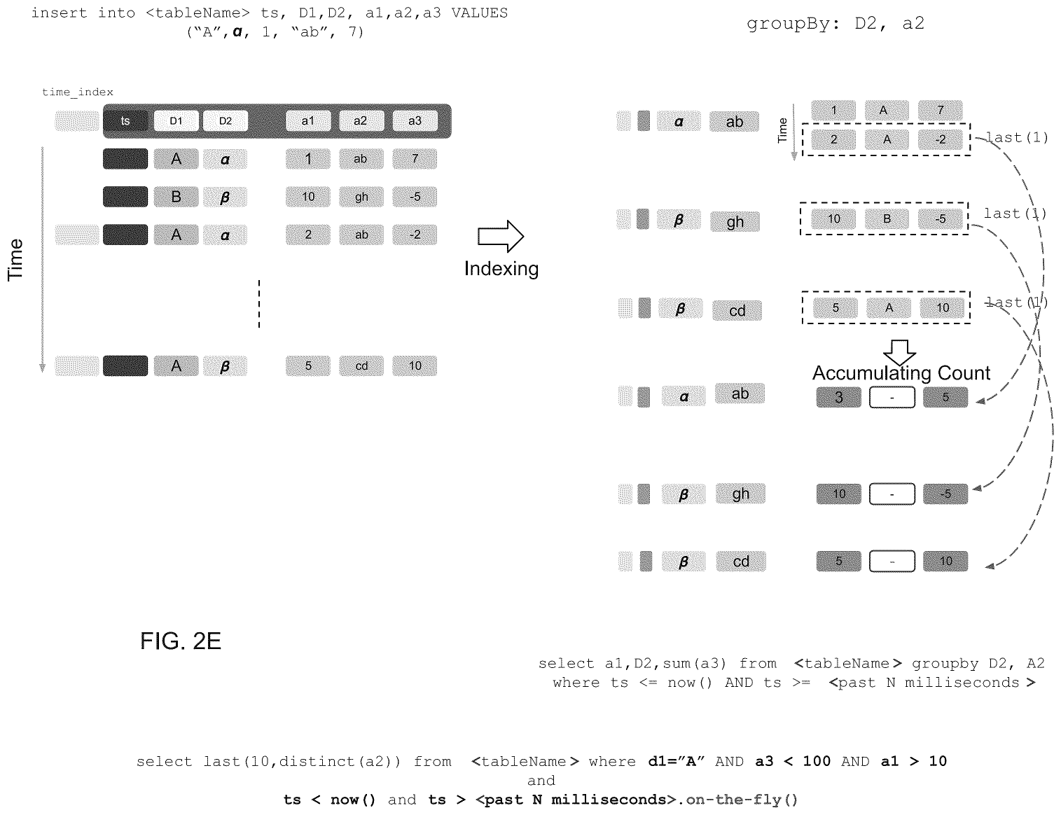

FIG. 2A conceptually illustrates an example counter ledger and example snapshot ledger in accordance with several embodiments of the invention. As will be discussed further below, compactor operations may be performed on the counter ledger to create entries in the snapshot ledger. While described as logs, the counter ledger and snapshot ledger may also be understood as tables or ledgers. Each row includes a number of fields. The fields include a timestamp, values for a plurality of dimensions, a value for an operation, and values for at least one counter state.

A counter ledger includes one or more rows of data, or counter entries. As illustrated in FIG. 2A, each counter entry includes a timestamp. As will be discussed further below, a timestamp is associated with each counter entry when it is sent from a data source to a counter ledger server. Timestamps maintain an ordering to the counter entries and distinguish them from each other.

A counter ledger may include N fields, referred to as dimensions D1 through Dn. In several embodiments of the invention, one or more dimensions may have a hierarchical relationship (e.g., Country->State->City-Zip Code), though dimensions are not all required be hierarchical.

In some embodiments of the invention, one or more dimensions are specified as, and limited to, a particular data type (e.g., string, numerical, enumerated type, etc.). When counter entries (rows) are written to the log, data validation can be performed on the dimension values of the incoming row to confirm that the values are valid according to the data types of the dimensions. When any values do not match the data type of their dimension, the row may be denied from being written. A notification may be sent to the client to request that the data be corrected and resent.

In the counter ledger, K fields, referred to as counter states, may be stored (dC1, dC2, . . . , dCk). In some embodiments of the invention, an operation field specifies what type of value is stored. When the operation field value represents “set,” the counter state may represent an absolute value of the counter. When the operation field value represents “delta,” the counter state may represent a change from a previous value of the counter (a delta operation), e.g., +1, +5, −2, +0.5 etc. As discussed further below, counter operations may be performed to update the counters by sending additional counter entries to be written to the counter ledger. The counter ledger is immutable such that each row that is written to the log is atomic and isolated. In case an application retries a write operation, it results in an overwrite, causing mutation.

At periodic intervals, a compactor may execute on the counter ledger to generate snapshots. A snapshot can include any or all of the N dimensions as well any or all of the K counter states. Upon compaction of the counter ledger, log entries between the start and end time of the designated interval are aggregated to generate snapshots as of the end time (e.g., ts3 and ts6 in FIG. 2A). In many embodiments of the invention, snapshots can be written to and maintained in a snapshot ledger. In several embodiments, each row of a snapshot ledger includes a timestamp that is the latest timestamp of the counter entries that were aggregated to the snapshot, values of one or more dimensions, and values of one or more counters. The dimension values of a snapshot remain as the values of the counter entries that were matched to generate the snapshot. The counter values are accumulated given set values and any deltas after a set value. In several embodiments of the invention, multiple snapshot ledgers may be maintained with different dimensions and/or counters included in each log.

The periodic snapshots can be provided when a data customer requests a snapshot. For example, a getCounters request may be provided, where the parameters for the request are the particular dimensions and the PREFERENCE input, as described above and seen in FIG. 2A. When the PREFERENCE input is set to ASOF, the function may receive an additional timestamp parameter. As seen in FIG. 2A, the snapshots (snapshot ledger) are immutable where each row that is written is atomic and isolated. In case a compactor performs a retry, the operation results in an overwrite.

Per the described techniques, all writes are atomic and isolated. Quorum consistency is maintained across a number of copies of a counter ledger and/or a snapshot ledger across any number of data centers. In some embodiments of the invention, a minimum of 3 copies may be maintained for data resiliency. Each copy of the data is available for reads and writes by an application in a non-blocking manner. In different embodiments of the invention, any of a variety of techniques may be utilized to maintain consistent and synchronized copies of counter ledgers and/or snapshot ledgers. Further, if different copies of a counter are out of sync, the described techniques enable repair on the fly across the multiple copies (e.g., three or more copies). Systems and methods for replica-aware clients and client-driven quorum are described in U.S. Pat. Pub. No. 2023/0036832 to Rawal et al., the relevant disclosure of which is incorporated by reference in its entirety.

The techniques can enable the distributed storage (e.g., database) maintained by the server system (that receives the requests) to perform the operations with no locks/transactions in the whole system. Counter ledgers and snapshot ledgers in accordance with embodiments of the invention eliminate the need for an application to perform a read before updating a counter value, thus eliminating requests of the form of “Compare-and-set.” The techniques enable the application to perform state machine management, e.g., +1 order, −1 available vs. +1 order, for the counter. The techniques also enable adjusting compactor frequency based upon incoming throughput (e.g., a few 100 s of ms to 10 s of seconds) of requests.

While a specific counter ledger is described above with respect to FIG. 2A, one skilled in the art will recognize that any of a variety of tables and table configurations may be utilized in accordance with embodiments of the invention.

### Counter Operations

### UpdateCounters Operation

An UpdateCounters operation enables a counter update application on a data source to update one or more counters stored by the counter ledger server. The UpdateCounters operation can be implemented as an API on the client device that enables a counter update application to make requests to a server to update a counter. An API call may be of the form:
bool updateCounters(List <Dimensions>, Counters[CounterName, value], operationId)

An UpdateCounters API call may be converted into a counter update request to update the specified counter(s) that is sent to a server. The counter update request can include the listed values for dimensions, values for counters, and operation type and may also append a timestamp. In some embodiments of the invention, if dimension or counter values are not provided, the data source may insert default values. Alternatively, the data source may leave the fields blank and the counter ledger server inserts default values when the counter update request is received. In further embodiments of the invention, a request may be rejected if it is missing values. In several embodiments of the invention, a counter update request can include multiple counter entries (rows) that should all be written to the counter ledger.

In several embodiments of the invention, the timestamp is generated by the client and can be used by the server to prevent double counting in the event of conflict or failure. Techniques for resolving conflicts and failures to write are described in U.S. Pat. Pub. No. 2023/0036832 to Rawal et al., the relevant disclosure of which is incorporated by reference in its entirety. Furthermore, a client identifier (clientID) can be included in the counter update request. In the case of a UUID (Universally Unique Identifier), the identifier may inherently convey a clientID.

In some embodiments of the invention, a time-based UUID is used as a timestamp, which is based on the current time and an identifier of the client, which may be a MAC address (actual or randomly generated) which is globally unique.

In a timestamp-first UUID, the current time forms the beginning of the identifier. This has the benefit that when sorting by UUID they will appear in the order created, which is useful when the UUID is used as a primary key in a database.

The client may resend the counter update request to the server in any of a number of scenarios, such as: if the server reports failure or does not acknowledge completion of the update, a timeout period passes without receiving a response from the server, or due to a network failure no response is received from the server. A client may be configured to retry sending the counter update request a predetermined number of times, then if still not successful, spool the counter update request to retry later. Techniques for spooling, write-once semantics and deduplication in distributed systems are described in U.S. Pat. Pub. No. 2023/0036832 to Rawal et al., the relevant disclosure of which is incorporated by reference in its entirety.

Upon receipt of a counter update request by a counter ledger server, the counter ledger server performs a write to a counter ledger. The write may be an atomic write for all the counter ledger entries in the counter update request with exactly-once semantics.

In some embodiments of the invention, a counter update request may pass in an optional operation identifier. The operation identifier can specify whether the counter values are “set” (absolute value) or are “delta” (change from a previous value). In other embodiments of the invention, different types of requests may be used to specify the operation instead of using an operation identifier. For example, a counter update request may indicate “delta” counter values, while a counter set request may indicate “set” counter values. While “delta” and “set” are the terms used here, one skilled in the art will understand that they simply enumerate possible labels for the given meaning and different labels may be utilized for the same operational meaning in other embodiments of the invention.

A data customer may make counter snapshot requests to a counter ledger server with one or more parameters. A counter snapshot request can include a request for counter data stored by the server, and more specifically for a snapshot of counter data. A snapshot includes the state(s) of one or more counters given the timing criteria in the request.

Upon receiving a counter snapshot request, a counter ledger server may use a query optimizer can use the most optimal features to service the query while performing the correct trade-offs of performance, cost and accuracy. Specifically, two abilities are provided. First, an ability to only scan data across some time window from NOW( ), ASOF (some ts in past) until some End time (in the past). Second, an ability to utilize the user-defined indexes/features ONLY or merge them with the most up-to-date raw data written. This would result in the freshest state of data at the cost of more performance. Different applications can choose different trade-offs as needed.

A counter snapshot request may be of the form:
getCounters(List <Dimensions>, PREFERENCE)

The counter snapshot request can include a list of dimensions for which counter states are to be aggregated and returned. For example, a hierarchical set of dimensions can include COUNTRY, STATE, CITY, ZIP CODE. In various examples, the dimensions may be at different aggregation levels.

The request can also include a PREFERENCE. The counter snapshot uses the PREFERENCE input value to indicate the option for timing criteria that is to be utilized when accessing counters. Some examples of values that the PREFERENCE input value can take include:

PERFORMANCE—Provide the latest computed snapshot. When this option is included in the counter snapshot request from a data customer, the response includes data from the latest computed snapshot. Such requests can often be returned faster because of less additional computation that would be performed. In some embodiments, PERFORMANCE is assumed as default when no PREFERENCE is indicated in a request.

RECENCY—Provide the up-to-date value. When this option is included in the counter snapshot request, the response includes the result of compaction performed on the latest computed snapshot data with any counter entries (rows) that were written to the counter ledger after that snapshot (i.e., having later timestamps). Recency may also be indicated by an “on the fly” flag in a snapshot request.

ASOF (with timestamp)—This option is a middle ground of PERFORMANCE and RECENCY. This option allows partial compaction of deltas. For example, when this option is included in the counter snapshot request, the response includes data with compaction only of additional counter entries that meet the timestamp criteria (e.g., deltas that store data values associated with timestamps that are less than or equal to the value indicated in the counter snapshot request.

The output (e.g., response to a counter snapshot request using one of the PREFERENCE options in the inputs described above) may include a snapshot of counters. The data can includes CounterName. For example, the CounterName may be specified by the application and may be application specific. For example, in an e-commerce application, the application-defined counters may include respective counters for each inventory state, e.g., AVAILABLE, RESERVED, PROCESSING, COMPLETED. The output can include a value, e.g., a numerical (can be decimal) value of a particular counter associated with the CounterName.

FIG. 2B, shows a counter ledger (on the left) that is indexed by timestamp and grouped by dimension D1 value (on the right). Accumulated counts show counter snapshots taken of the counter ledger by dimension D1 (i.e., where the value of D1 is A, B, etc.). Where dimension D1 is A, the accumulated count for counter state a1 is 8 and counter state a3 is 15. Where dimension D1 is B, the accumulated count for counter state a1 is 10 and counter state a3 is −5.

Counter snapshots and queries of a counter ledger may utilize a Last-N criteria in accordance with embodiments of the invention that returns the most recent (by timestamp) counter entries or rows of data that match the other criteria provided in the query. For example, a query having a criteria Last-N where N is 3 and dimension D1 is A would return the three rows shown in the “Last-N” box. A query having a criteria Last-N where N is 1 and dimension D1 is A would return the three rows shown in the “last(1)” box.

FIG. 2C, shows a counter ledger (on the left) that is indexed by timestamp and grouped by unique combinations of dimension D1 and D2 values (on the right). Accumulated counts show counter snapshots taken of the counter ledger by combinations of dimension D1 and D2 (i.e., where the value of D1 is A and D2 is α, where the value of D1 is B and D2 is β, where the value of D1 is A and D2 is β, etc.). Where dimension D1 is A and D2 is α, the accumulated count for counter state a1 is 3 and counter state a3 is 5. Where dimension D1 is B and D2 is β, the accumulated count for counter state a1 is 10 and counter state a3 is −5. Where dimension D1 is A and D2 is 3, the accumulated count for counter state a1 is 5 and counter state a3 is 10. A query having a criteria Last-N where N is 1 and given a unique combination of dimensions D1 and D2 would return the last row in that grouping.

FIG. 2D, shows a counter ledger (on the left) that is indexed by timestamp and grouped by unique combinations of dimension D2 and D1 values (on the right). Accumulated counts show counter snapshots taken of the counter ledger by combinations of dimension D2 and D1 (i.e., where the value of D2 is α and D1 is A, where the value of D2 is β and D1 is B, where the value of D2 is β and D1 is A, etc.). Where dimension D2 is α and D1 is A, the accumulated count for counter state a1 is 3 and counter state a3 is 5. Where dimension D2 is β and D1 is B, the accumulated count for counter state a1 is 10 and counter state a3 is −5. Where dimension D2 is β and D1 is A, the accumulated count for counter state a1 is 5 and counter state a3 is 10. A query having a criteria Last-N where N is 2 and given a unique combination of dimensions D1 and D2 would return the last two rows in that grouping. A query having a criteria Last-N where N is 1 and given a unique combination of dimensions D1 and D2 would return the last row in that grouping.

FIG. 2E, shows a counter ledger (on the left) that is indexed by timestamp and grouped by unique combinations of dimension D2 and counter state a2 values (on the right). Accumulated counts show counter snapshots taken of the counter ledger by combinations of dimension D2 and counter state a2 (i.e., where the value of D2 is α and a2 is ab, where the value of D2 is β and a2 is gh, where the value of D2 is β and a2 is cd, etc.). Where dimension D2 is α and a2 is ab, the accumulated count for counter state a1 is 3 and counter state a3 is 5. Where dimension D2 is β and a2 is gh, the accumulated count for counter state a1 is 10 and counter state a3 is −5. Where dimension D2 is β and a2 is cd, the accumulated count for counter state a1 is 5 and counter state a3 is 10. A query having a criteria Last-N where N is 1 and given a unique combination of dimension D2 and counter state a2 would return the last row in that grouping.

### Computing Devices

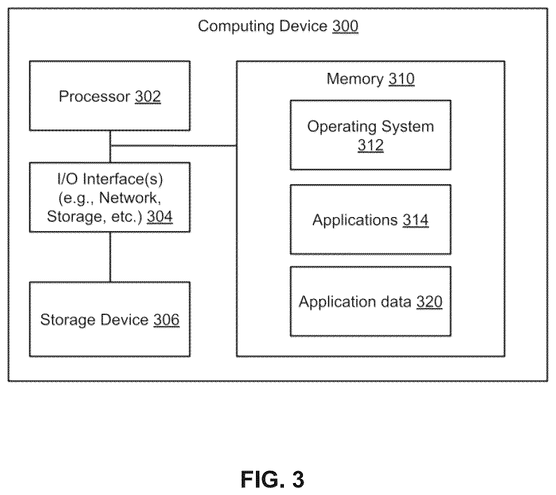

FIG. 3 is a block diagram of an example computing device 300 which may be used to implement one or more features described herein. In one example, device 300 may be used to implement a computer device, e.g., a data stream storage, or analytics device, and perform appropriate method implementations described herein. Device 300 can be any suitable computer system, server, or other electronic or hardware device. For example, the device 300 can be a mainframe computer, server computer, desktop computer, workstation, portable computer, or medical device. In some implementations, device 300 includes a processor 302, input/output (I/O) interface 304, one or more storage devices 306, and a memory 310.

Processor 302 can be one or more processors and/or processing circuits to execute program code and control basic operations of the device 300. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 310 is typically provided in device 300 for access by the processor 302 and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 302 and/or integrated therewith. Memory 310 can store software operating on the server device 300 by the processor 302, including an operating system 312, one or more applications 314, and application data 320. In some implementations, applications 314 can include instructions that enable processor 302 to perform the functions described herein. Memory 310 also stores application data 320.

For example, applications 314 can include one or more applications that utilize the API as described herein, with reference to FIG. 2A.

Any of software in memory 310 can alternatively be stored on any other suitable storage location or computer-readable medium. In addition, memory 310 (and/or other connected storage device(s)) can store other instructions and data used in the features described herein. Memory 310 and any other type of storage (magnetic disk, optical disk, magnetic tape, or other tangible media) can be considered “storage” or “storage devices.”

I/O interface 304 can provide functions to enable interfacing the computing device 300 with other systems and devices. For example, network communication devices, external storage devices, and other input/output devices can communicate via interface 304. In some implementations, the I/O interface 304 can connect to interface devices including input devices (keyboard, pointing device, touchscreen, microphone, camera, scanner, etc.) and/or output devices (display device, speaker devices, printer, motor, etc.).

Storage device 306 is one example of a storage device, e.g., a solid-state storage device, a hard disk drive, etc. that can be used by operating system 312 and/or one or more applications 314. Storage device 306 is a direct attached storage device, e.g., coupled to processor 302 and directly controlled by processor 302. Processor 302 is coupled to I/O interface(s) 304, storage device 306, and memory 310 via local connections (e.g., a PCI bus, or other type of local interface) and/or via networked connections.

For ease of illustration, FIG. 3 shows one block for each of processor 302, I/O interface 304, storage device 306, and memory 310 with software blocks 312, 314, and 320. These blocks may represent one or more processors or processing circuitries, operating systems, memories, I/O interfaces, applications, and/or software modules. In other implementations, device 300 may not have all of the components shown and/or may have other elements including other types of elements instead of, or in addition to, those shown herein. Any suitable component or combination of components of system 142 or similar system, or any suitable processor or processors associated with such a system, may perform the operations to provide and/or utilize the API as described herein.

A user device can also implement and/or be used with features described herein. Example user devices can be computer devices including some similar components as the computing device 300. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices.

While specific systems are described above with respect to FIG. 3, one skilled in the art will recognize that any of a variety of system configurations may be utilized in accordance with embodiments of the invention.

### Processes for Updating Counters and Reading Counters

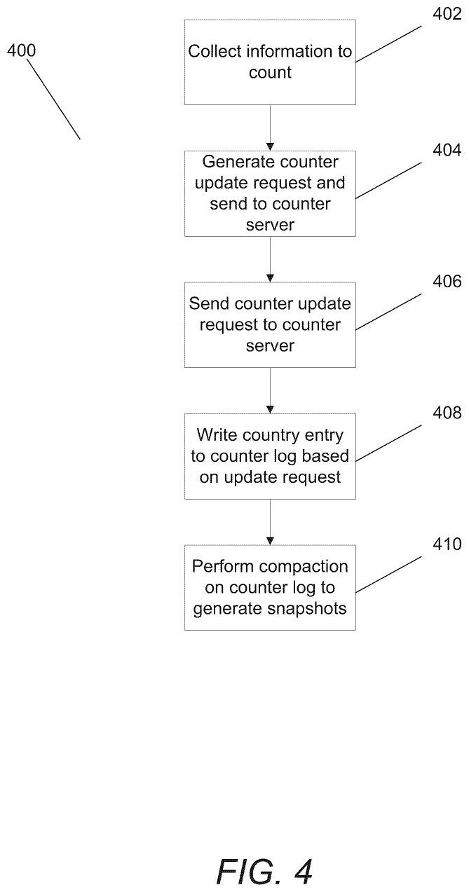

A process for updating counters in accordance with embodiments of the invention is illustrated in FIG. 4. The process 400 includes collecting (402), on a client device, contextual information concerning an item or occurrence to count. The contextual information can include or can be converted to values that would apply for dimensions and counter states. The client device generates (404) a counter update request that includes the dimension values, counter state values, and an operation value. As discussed further above, operation values can include, but are not limited to, “delta” to represent a change to a counter (e.g., plus or minus a number) and “set” to set the counter to the provided counter state value. A client device may be a type of server but can still be referred to as a client device in the sense that it sends data to a counter server.

The client device sends (406) the counter update request to a counter ledger server to update the relevant counters. The counter ledger server writes (408) counter entries to the counter ledger from the counter update request. In many embodiments of the invention, the counter is updated across multiple copies of the counter ledger that are maintained in a distributed system.

The counter server performs compaction (410) on the counter ledger to create counter snapshots on one or more snapshot ledgers. In many embodiments of the invention, compaction is asynchronous to requests that arrive and is instead governed by a configured frequency. One or more compaction processes may execute on the counter server (e.g., to process multiple snapshot ledgers).

The process of compaction generally consolidates and accumulates counters for each counter state to maintain a current count. A snapshot ledger can be generated for any or all dimensions that are present in a counter ledger. In many embodiments, a snapshot ledger contains snapshot entries, where each entry includes a timestamp (generally the timestamp of the most recent counter entry used to generate the snapshot entry), one or more dimensions, and accumulated count values for one or more counter states.

Compaction can involve identifying a counter snapshot in a snapshot ledger that has the most recent timestamp (a latest counter snapshot). Counter entries from the counter ledger are identified that have dimension values that match the dimensions for a snapshot to be created (and the latest counter snapshot) and have timestamps that are later than the timestamp of the latest counter snapshot. A new counter snapshot can be generated that takes the latest timestamp of the selected counter entries, the same dimension values, and at least one snapshot counter value, where each snapshot counter value is calculated from corresponding counter state values of the selected counter entries and the latest counter snapshot. The new snapshot counter value considers any values by “set” operation (taking the most recent set value), any values by “delta” operation (adding or subtracting by delta values), and the snapshot counter value of the latest counter snapshot (if more recent than all set values) to calculate the sum total.

Additional techniques for compaction are described in U.S. Pat. Pub. No. 2023/0054341 to Rawal et al., the relevant disclosure of which is incorporated by reference in its entirety.

Additional snapshot ledgers can be created that have less granularity. For example, a snapshot ledger may have larger time intervals in its counter snapshots. A snapshot ledger with a larger time interval can be generated from one that has a smaller time interval by compacting the snapshots having a smaller time interval, which can be more efficient than compacting the counter entries of the counter ledger. Counter snapshots can be selected from the smaller time interval snapshot ledger that fall within a larger time interval and compacted for each larger time interval by summing the snapshot counter values for each counter state. Each counter snapshot for each larger time interval can include the summed snapshot counter values and the timestamp of the latest counter snapshot of each larger time interval.

Efficiency can also be realized when generating a counter snapshot that has the same, but fewer, dimensions as another counter snapshot. To achieve a first set of counter snapshots including a first dimension and a second set of counter snapshots including the first dimension and a second dimension, counter entries that match dimension values for the first dimension and the second dimension can be first compacted to generate the set of second counter snapshots. Then, counter snapshots from the second set of counter snapshots that match the first dimension can be compacted to generate each of the first set of counter snapshots.

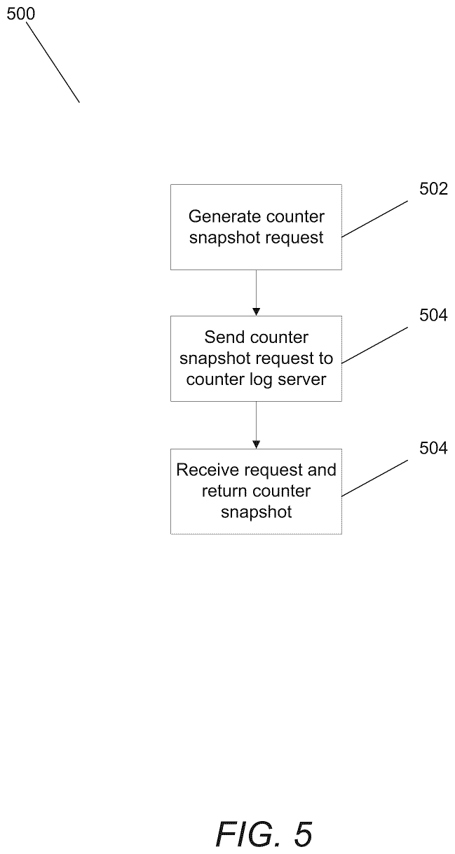

A process for requesting a counter snapshot in accordance with embodiments of the invention is illustrated in FIG. 5. The process 500 includes generating (5020 a counter snapshot request by a data customer. The counter snapshot request can include dimensions and a preference as discussed further above. The counter snapshot request is sent (504) to a counter ledger server. The counter ledger server returns (504) a snapshot that may be generated such as by a getCounters operation as discussed further above.

Although specific processes are discussed above with respect to FIGS. 4 and 5, one skilled in the art will recognize that any of a variety of processes may be utilized to update counter ledgers, generate snapshot ledgers, and request counter snapshots in accordance with embodiments of the invention as appropriate to a particular application.

One or more processes described herein (e.g., process 400 or 500) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc.

The program instructions can also be contained in, and provided as an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processing units (or GPUs) Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run in a web browser, a server application that executes on a single computer, a distributed application that executes on multiple computers, etc. In one example, a client/server architecture can be used, e.g., a mobile computing device (as a client device) sends user input data to a server device and receives from the server the final output data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations. Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A counter server, comprising:
a processor;
a network interface;
non-volatile memory comprising:
a counter ledger comprising an immutable table where each entry includes values for fields of:
a first timestamp;
an operation, where the available values for the operation include at least “delta” and “set”;
a first plurality of dimensions, each dimension restricted to values having a particular data type; and
a first at least one counter state, each counter state restricted to values that are numerical;
a counter analytics application that, when executed, instructs the processor to:
receive a counter update request, where the counter update request includes at least one counter entry that each includes a timestamp, an operation value, a first plurality of dimension values, and at least one counter value;
write the at least one counter entry to the counter ledger;
reading a latest counter snapshot from an immutable snapshot ledger, where the latest counter snapshot has the most recent timestamp of counter snapshots in the snapshot ledger;
select counter entries from the counter ledger for compaction given a second plurality of dimension values, where the counter entries are selected by having dimension values matching those of the second plurality of dimension values and having a timestamp after the time of the latest counter snapshot;
generate a new counter snapshot from the latest counter snapshot and the selected counter entries in the counter ledger at a predefined time interval, where the new counter snapshot includes:
the second plurality of dimension values;
a second timestamp taken from the most recent timestamp of the selected counter entries;
at least one snapshot counter value, where each snapshot counter value is calculated from corresponding counter state values of the selected counter entries and the latest counter snapshot;
write the new counter snapshot to the snapshot ledger.

2. The counter server of claim 1, wherein the counter analytics application further instructs the processor to generate a second new counter snapshot at a next time interval.

3. The counter server of claim 1, wherein the counter analytics application instructs the processor to generate entries for a second snapshot ledger having less frequency of the snapshot ledger by:
selecting counter snapshot entries from the snapshot ledger that fall within a larger time interval than the predefined time interval;
compacting the selected counter entries for each larger time interval by summing the snapshot counter values for each counter state; and
writing at least one second counter snapshot entry to the second snapshot ledger having the summed snapshot counter values and the timestamp of the latest selected counter snapshot entry.

4. The counter server of claim 1, wherein the counter analytics application instructs the processor to perform compaction to generate a first set of counter snapshots including a first dimension and a second set of counter snapshots including the first dimension and a second dimension by:
compacting a plurality of counter entries that match dimension values for the first dimension and the second dimension to generate the set of second counter snapshots;
compacting counter snapshots from the second set of counter snapshots that match the first dimension to generate each of the first set of counter snapshots.

5. A counter server, comprising:
a processor;
a network interface;
non-volatile memory comprising:
a counter ledger comprising an immutable table where each entry includes values for fields of:
a first timestamp;
an operation, where the available values for the operation include at least “delta” and “set”;
a first plurality of dimensions, each dimension restricted to values having a particular data type; and
a first at least one counter state, each counter state restricted to values that are numerical;
a counter analytics application that, when executed, instructs the processor to:
receive a counter snapshot request from a client device, where the counter snapshot request includes at least a first plurality of dimension values;
when the counter snapshot request does not include an “on the fly” flag:
read a latest counter snapshot from an immutable snapshot ledger, where the latest counter snapshot has the most recent timestamp of counter snapshots in the snapshot ledger;
send the latest counter snapshot to the client device;
when the counter snapshot request includes an “on the fly” flag:
reading a latest counter snapshot from a snapshot ledger, where the latest counter snapshot has the most recent timestamp of counter snapshots in the snapshot ledger;
select counter entries from the counter ledger for compaction given a second plurality of dimension values, where the counter entries are selected by having dimension values matching those of the second plurality of dimension values and having a timestamp after the time of the latest counter snapshot;
generate a new counter snapshot from the latest counter snapshot and the selected counter entries in the counter ledger at a predefined time interval, where the new counter snapshot includes:
the second plurality of dimension values;
a second timestamp taken from the most recent timestamp of the selected counter entries;
at least one snapshot counter value, where each snapshot counter value is calculated from corresponding counter state values of the selected counter entries and the latest counter snapshot;
send the new counter snapshot to the client device.

6. A method for maintaining counters in a distributed system, the method comprising:
receiving a counter update request, where the counter update request includes at least one counter entry that each includes a timestamp, an operation value, a first plurality of dimension values, and at least one counter value;
writing the at least one counter entry to a counter ledger, where the counter ledger comprises an immutable table where each entry includes values for fields of:
a first timestamp;
an operation, where the available values for the operation include at least “delta” and “set”;
a first plurality of dimensions, each dimension restricted to values having a particular data type; and
a first at least one counter state, each counter state restricted to values that are numerical;
reading a latest counter snapshot from an immutable snapshot ledger, where the latest counter snapshot has the most recent timestamp of counter snapshots in the snapshot ledger;
selecting counter entries from the counter ledger for compaction given a second plurality of dimension values, where the counter entries are selected by having dimension values matching those of the second plurality of dimension values and having a timestamp after the time of the latest counter snapshot;
generating a new counter snapshot from the latest counter snapshot and the selected counter entries in the counter ledger at a predefined time interval, where the new counter snapshot includes:
the second plurality of dimension values;
a second timestamp taken from the most recent timestamp of the selected counter entries;
at least one snapshot counter value, where each snapshot counter value is calculated from corresponding counter state values of the selected counter entries and the latest counter snapshot;
writing the new counter snapshot to the snapshot ledger.
